(19) United States
(12) Patent Application Publication
(10) Pub. No.: US 2016/0363775 A1
(43) Pub. Date: Dec. 15, 2016

(54) HEAD WEARABLE BINOCULAR KALEIDOSCOPES

(71) Applicant: Oakes Snider, Portland, OR (US)

(72) Inventor: Oakes Snider, Portland, OR (US)

(21) Appl. No.: 15/181,220

(22) Filed: Jun. 13, 2016

Related U.S. Application Data
(60) Provisional application No. 62/174,294, filed on Jun. 11, 2015.

(51) Int. Cl. G02B 27/08; G02B 27/02

(52) U.S. Cl. CPC G02B 27/08; G02B 27/028

(57) ABSTRACT

Head wearable kaleidoscopes that include a plurality of kaleidoscope members placed into a mount. When the mount is secured on a user's head, the kaleidoscope members can be positioned in front of a user's eyes. In some examples, head wearable kaleidoscopes include a single kaleidoscope member and an optical system tor directing light passing through the single kaleidoscope member to each of the user's eyes. In some aspects of the head wearable kaleidoscope, the mount may be implemented as a visor, a helmet, or a pair of glasses.

### CROSS REFERENCE TO RELATED APPLICATIONS

This application claims priority to copending U.S. Provisional Application Ser. No. 6,217,4294, filed on 11 Jun. 2015, which is hereby incorporated by reference for ail purposes.

### BACKGROUND

The present disclosure relates generally to kaleidoscopes. In particular, head-wearable devices that include one or more kaleidoscopes that can be viewed with both eyes (binocular) are described.

A kaleidoscope is a viewable art and entertainment device including a tubular body housing three or more elongate mirrors. A user looks through one end of the tubular body, while the opposing end allows light (i.e., images) to enter the tube and provides an infinite regular grip of duplicate images. In some examples, the opposing end includes one or more rotatable objects (e.g., colored glass wheel, colored plastic wheel, clear wheel housing colored beads, etc.).

Known kaleidoscopes are not entirely satisfactory for the range of applications in which they are employed. For example, existing kaleidoscopes are monocular, allowing viewing with only a single eye during use. Accordingly, the user is required to hold only one eye closed during vision, or have the kaleidoscope image obscured by the normal view from the eye not engaged with the kaleidoscope. In addition, conventional kaleidoscopes require that the user carry, hold, and/or raise the kaleidoscope up to his or her eyes during use. Therefore, the user's hands are occupied by holding of the kaleidoscope and viewing; through the kaleidoscope is limited to the duration of time that the user can comfortably maintain the kaleidoscope in the raised position. Moreover, the user is required to carry and/or stop and put the kaleidoscope away when not in use.

Thus, there exists a need for head wearable binocular kaleidoscopes that improve upon and advance the design of known kaleidoscopes. Examples of new and useful head wearable binocular kaleidoscopes relevant to the needs existing in the field are discussed below.

Disclosure addressing one or more of the identified existing needs is provided in the detailed description below. Examples of references relevant to binocular systems and kaleidoscope systems include U.S. Patent References: Pat. No. 4,820,004, Pat. No. 5,020,870, Pat. No. 5,281,139, Pat. No. 6,598,981, and Pat. No. 7,031,068. The complete disclosures of the above patents are herein incorporated by reference for all purposes.

### SUMMARY

The present disclosure is directed to a head wearable kaleidoscope that includes a plurality of kaleidoscope members placed into a mount. When the mount is secured on a user's head, the kaleidoscope members can be positioned in front of a user's eyes.

In some implementations, the mount can comprise a visor.

One aspect of the invention includes a strap that allows the visor to be retained upon the user's head.

In other implementations, the mount can comprise a helmet.

Aspects of the invention implemented as a helmet Include a shell equipped with a pivoting arm that serves as the mount, which can be pivoted to move the kaleidoscope members a user viewing position and a storage position.

In still other implementations, the mount can comprise a pair of eyeglasses.

Another aspect of the invention includes a mount configured to allow the kaleidoscope members to slide between retracted and use positions.

Still other aspects of the invention include kaleidoscope members implemented as teleidoscopes, or including rotatable viewing objects around each kaleidoscope member's light inlet.

Other embodiments of the head wearable kaleidoscope include a single kaleidoscope member that distributes light from the kaleidoscope member to each of the user's eyes via an optical system.

Some aspects of this embodiments include an optical system comprised of mirrors, or comprised of prisms or other refractive elements.

### BRIEF DESCRIPTION OF THE DRAWINGS

FIG. 1 is a perspective view of a first example of a head wearable binocular kaleidoscope.

FIG. 2 is a front elevation view of the head wearable binocular kaleidoscope shown in FIG. 1 depicting the front of the kaleidoscope modules where light is received.

FIG. 3 is a rear elevation view of the head wearable binocular kaleidoscope shown in FIG. 1 depicting the rear of the kaleidoscope modules and associated eyepieces where a user views light coming from the kaleidoscope modules.

FIG. 4 is a top view of the head wearable binocular kaleidoscope shown in FIG. 1 depicting the kaleidoscope modules in a retracted position for storage.

FIG. 5A is a perspective view of a second example of a head wearable binocular kaleidoscope including the kaleidoscope modules and mount being affixed to a helmet, with the mount positioned above the user's eyes.

FIG. 5B is a perspective view of the second example of a head wearable binocular kaleidoscope shown in FIG. 5A depicting the mount positioned in front of the user's eyes for use.

FIG. 6 is a perspective view of a third example of a head wearable binocular kaleidoscope including the kaleidoscope modules being affixed to a pair of glasses.

FIG. 7 is a perspective view of a fourth example of a head wearable binocular kaleidoscope including a visor with a single kaleidoscope module attached to an optical system that distributes light passing through the module to both of the user's eyes.

### DETAILED DESCRIPTION

The disclosed head wearable binocular kaleidoscopes will become better understood through review of the following detailed description in conjunction with the figures. The detailed description and figures provide merely examples of the various inventions described herein. Those skilled in the art will understand that the disclosed examples may be varied, modified, and altered without departing from the scope of the inventions described herein. Many variations are contemplated for different applications and design considerations; however, tor the sake of brevity, each and every contemplated variation is not individually described in the following detailed description.

Throughout the following detailed description, examples of various head wearable binocular kaleidoscopes are provided. Related features in the examples may be identical, similar, or dissimilar in different examples. For the sake of brevity, related features will not be redundantly explained in each example. Instead, the use of related feature names will cue the reader that the feature with a related feature name may be similar to the related feature in an example explained previously. Features specific to a given example will be described in that particular example. The reader should understand that a given feature need not be the same or similar to the specific portrayal of a related feature in any given figure or example.

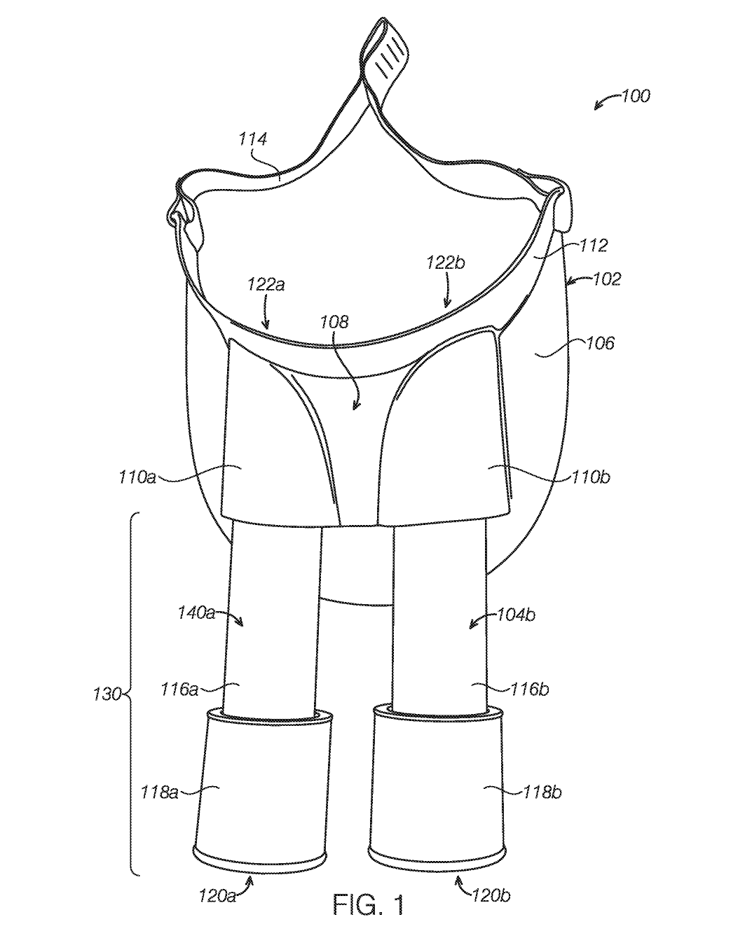

With reference to FIGS. 1-4 a first example of a visor-mounted kaleidoscope, kaleidoscope 100, will now be described. Kaleidoscope 100 functions to provide a wearable binocular kaleidoscope for selective viewing by a user. Specifically, during wear, kaleidoscope 100 is movable between a raised position (i.e., a non-kaleidoscope viewing position) and a lower position (i.e., a kaleidoscope viewing position). Additionally or alternatively, kaleidoscope 100 includes kaleidoscopes that are movable and/or slidable between an extended position (i.e., a wearable position) and a retracted position (i.e., a storage position).

Kaleidoscope 100 addresses many of the shortcomings existing with conventional kaleidoscopes. For example, kaleidoscope 100 provides a kaleidoscope view tor both eyes of a user so that the kaleidoscope view is not obscured by a normal view from one of the eyes of the user. In another example, the head mount of kaleidoscope 100 allows the user to use the kaleidoscopes without use of the user's hands (i.e., hands-free). The user can instead use their hands to operate/rotate the kaleidoscopes, perform some other activity, or allow their hands to remain in a resting position. In even another example, when not in use, the user can either wear the kaleidoscope in a raised position (i.e., a non-viewing position) or store the kaleidoscope with the kaleidoscope members in a retracted position.

As shown in FIG. 1, kaleidoscope system 100 includes a head wearable mount 102 and extendable and retractable kaleidoscope members 104a and 104b. Further, mount 102 includes a visor 106, a binocular kaleidoscope scaffold 108 having kaleidoscope receiving channels 110a and 110b, a vertical curved wall 112, and a headband 114.

Kaleidoscope members 104a and 104b can be implemented as any type of kaleidoscope device now known or later invented. In the preferred embodiment, kaleidoscope members 104a and 104b each include a tubular main body (i.e., main body 116a and 116b, respectively) and a rotatable tabular attachment (i.e., rotatable attachment 118a and 118b, respectively). An outer end of each kaleidoscope member 104a and 104b is a light inlet 120a and 120b, respectively. An opposing inner end of each kaleidoscope is an eye viewing region (i.e., light outlets 122a and 122b, which each comprise an integrated eyepiece). In other examples, the kaleidoscope system can additionally include a rotatable viewable object (e.g., colored glass wheel, colored plastic wheel, clear wheel housing colored beads, etc.) mounted to the light inlet, which can be rotatable with the rotatable tubular attachments or independently rotatable. Kaleidoscope members 104a and 104b are constructed from materials typical to the construction of kaleidoscopes, such as cardboard, paper, plastic, metal, composites, or other similar materials.

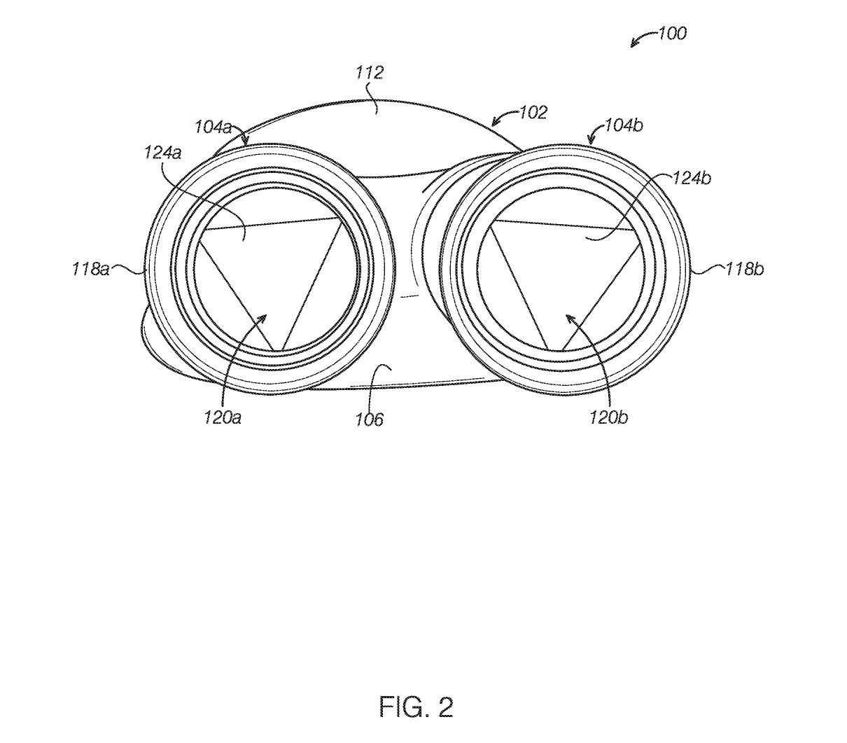

As can be seen in FIG. 2, rotatable attachments 118a and 118b each include a mirror assembly 124a and 124b, respectively. In the present example, each of the mirror assemblies has three mirrors that are joined at their longitudinal edges to form a triangular prism shape. The reflective surfaces of the mirrors each face in towards a center of the triangular prism shape so that light (i.e., images) appears infinitely reflected off of the other mirrors. In the present example the kaleidoscope is a teleidoscope, as the internal mirror assemblies reflect the user's surroundings. Light inlets 120a and 120b may optionally be equipped with lenses to protect the internal structures of each kaleidoscope member 104a and 104b. Mirror assemblies 124a and 124b can be manufactured from any suitably reflective material now known or later developed, such as silvered glass, plastic, or metal. By mounting mirror assemblies 124a and 124b into rotatable attachments 118a and 118b, respectively, the mirror assemblies can be rotated to change the view experienced by the user.

It will be appreciated that in alternate examples, the mirror assemblies can include more mirrors (e.g., 4, 5, 6, etc.) joined at their longitudinal edges to form a corresponding 3-D shape (e.g., cuboid, pentagonal prism, hexagonal prism, etc.). As referenced above, some kaleidoscopes may additionally include one or more inserted objects within rotatable attachments 118a and 118b to present ever-changing patterns that are independent from the user's surroundings. Additionally or alternatively, the rotatable tubular attachments can be excluded and the mirror assemblies can be housed by the tubular main bodies. In these examples, the main bodies may be rotatable within the kaleidoscope receiving channels. Further, the kaleidoscope can be any type of kaleidoscope known or yet to be discovered.

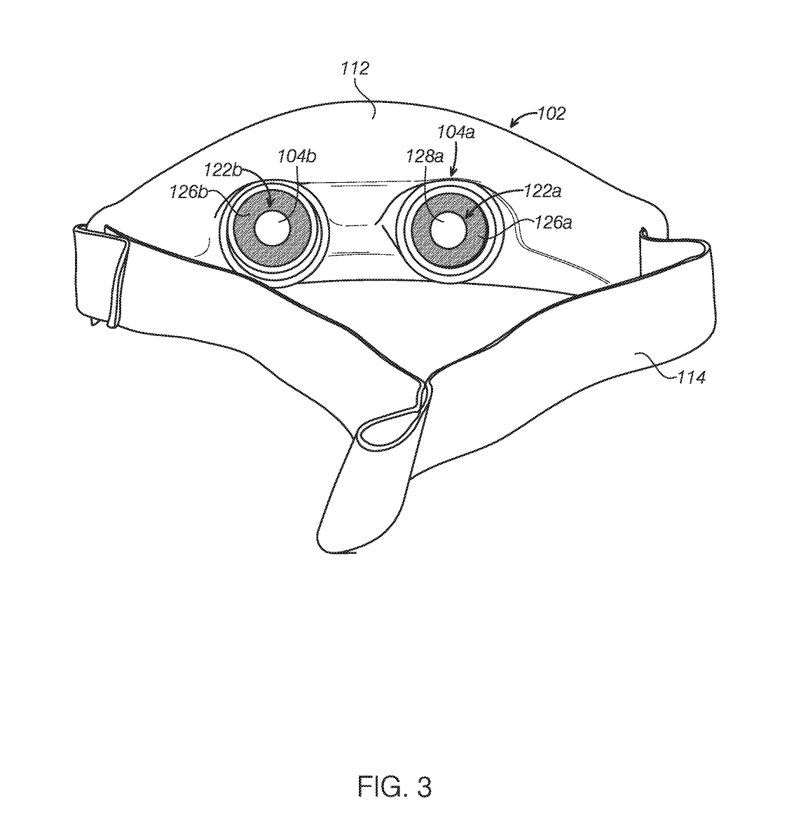

FIG. 3 shows an opposing view of kaleidoscope members 104a and 104b, where the user looks through in order to view the images reflected in mirror assemblies 124a and 124b. Specifically, images reflected in kaleidoscope member 104a can be viewed through light outlet 122a and images reflected in kaleidoscope member 104b can be viewed through light outlet 122b. In the present example, light outlets 122a and 122b each include an opaque disc 126a and 126b with a central transparent window 128a and 128b. In the present example, the central window is round, however, in other examples, the central window can have a different shape (e.g., triangular, square, etc.). Central transparent windows 128a and 128b can be manufactured from any suitable transparent material, such as glass or plastic of various types. Furthermore, central transparent windows 128a and 128b could be tinted to act as filters, or shaped as lenses to provide further alteration of the user's view or provide correction where a user may have defective vision.

As described above, mount 102 includes visor 106, binocular kaleidoscope scaffold 108 having kaleidoscope receiving channels 110a and 110b, vertical curved wall 112, and headband 114. Vertical curved wall 112 and headband 114 are configured to encompass the perimeter of a user's head. In the present example, headband 114 is comprised of a resilient material (e.g., elastic) that is in stretched state when worn by the user in order to generally maintain attachment to the user's head. In other examples, the head band can have a different configuration (e.g., non-resilient material straps tightenable via a strap, plastic molded straps having matable projections and holes, etc.).

When attached and/or secured to the user's head, mount 102 is movable between raised position and a lowered position. In the raised position, the visor is disposed above the user's eyes and is configured to block direct sunlight from the user's eyes. Further, in the raised position, the kaleidoscope light outlets are not aligned with (i.e., not viewable by) the user's eyes. Alternatively, in the lowered position, the visor is disposed below the user's eyes and the kaleidoscope light outlets are aligned with and viewable by the user's eyes. Mount 102 can be manufactured from any suitable material or materials, such as plastic, wood, metal, composites or other suitable material now known or later developed. Likewise, visor 106 is preferably manufactured from similar materials to mount 102. In the preferred embodiment visor 106 is integrated into mount 102 and manufactured from the same materials, but could be manufactured from different materials.

The user can easily manipulate the head mount between the raised and lowered positions. Thus, the user can easily switch between a normal view and a kaleidoscope view. The kaleidoscope view may obscure the user's view, which can be hazardous during certain conditions, such as when walking. Therefore, kaleidoscope system 100 has the advantage that the user can easily switch between a normal view and a kaleidoscope view as desired.

FIGS. 1-3 show kaleidoscope members 104a and 104b are shown in an extended position 130. In extended position 130, tubular main bodies 116a and 116b are extended outwardly from kaleidoscope receiving channels 110a and 110b and light outlets 122a and 122b are substantially aligned with vertical curved wall 112. Therefore, extended position 130 is a wearable position.

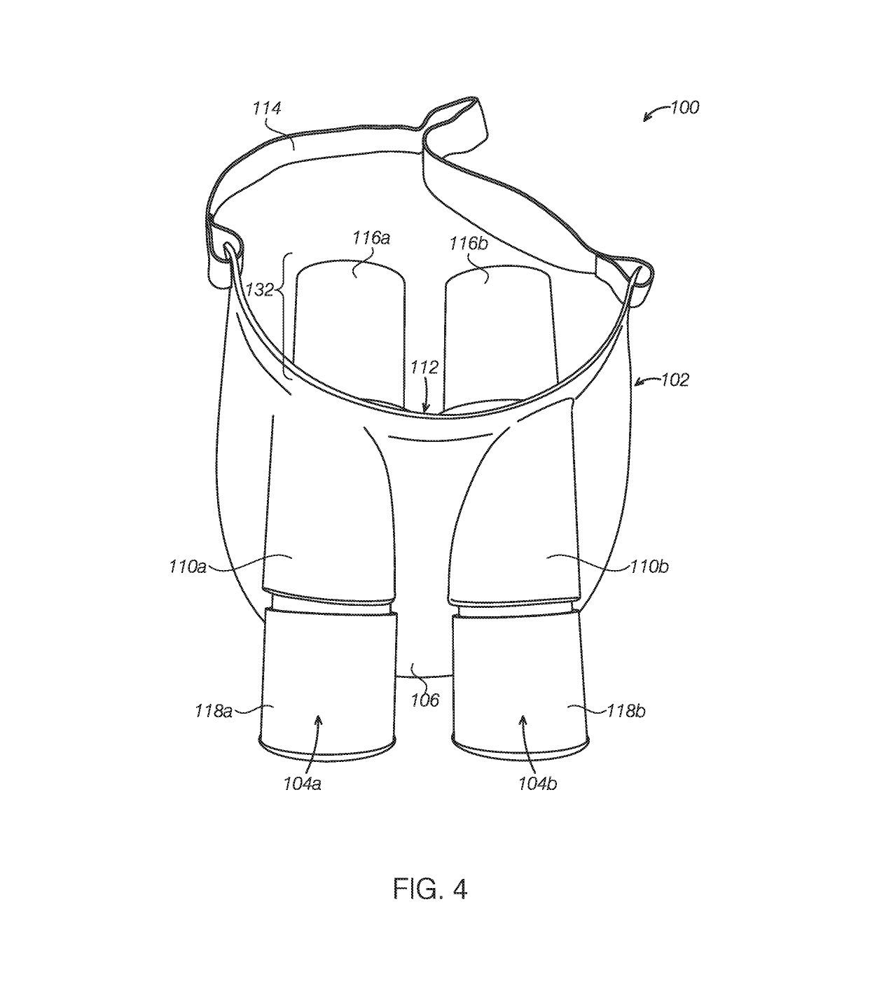

Alternatively, FIG. 4 shows kaleidoscope members 104a and 104b in a retracted position 132. In retracted position 132, tubular main bodies 116a and 116b are extended inwardly from channels 110a and 110b. Further, rotatable attachments 118a and 118b are abutted to an outer surface of receiving channels 110a and 110b (i.e., an outer surface of binocular kaleidoscope scaffold 108). As light outlets 122a and 122b are projected inward relative to vertical curved wall 112, retracted position 132 is a storage position (i.e., a non-wearable position).

It will be appreciated that kaleidoscope members are movable and/or slidable between extended position 130 and retracted position 132. Thus, when a user desires to use and/or wear the kaleidoscope system, the kaleidoscope members can be moved or slid into the extended position. When the user desires to store and/or earn/ the kaleidoscope system, the kaleidoscope members can be moved and/or slid into the retracted position. The retracted position has the advantage that the overall dimensions of the kaleidoscope system are reduced.

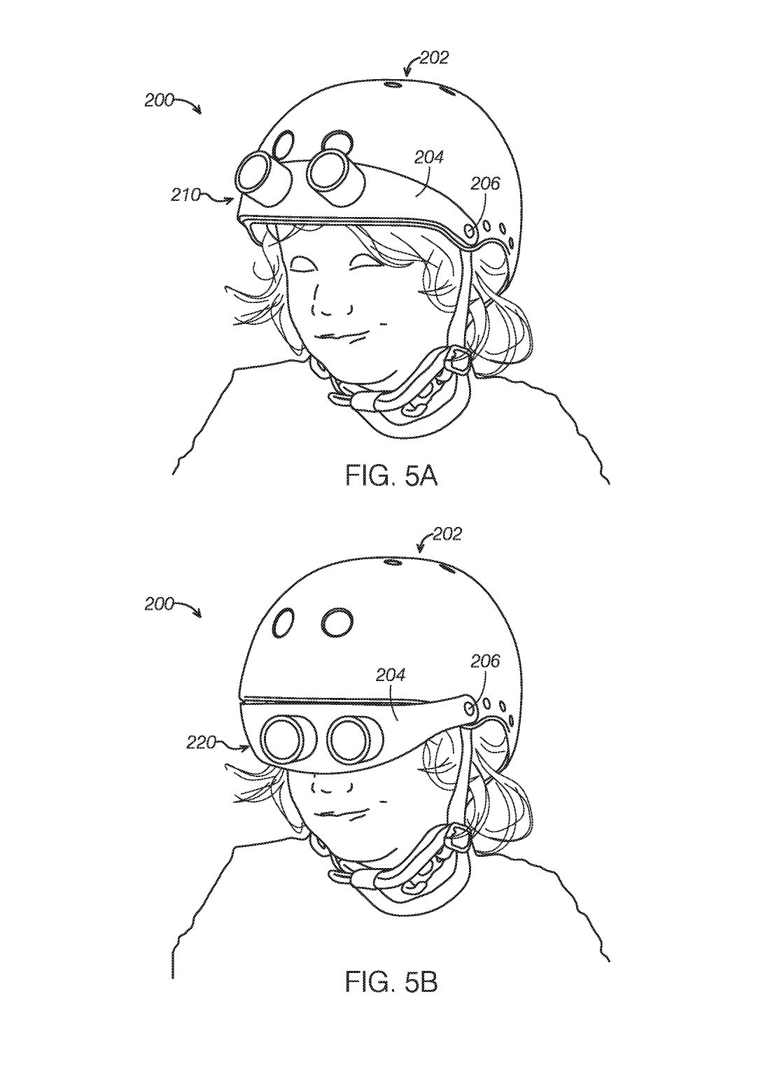

Turning attention to FIGS. 5A and 5B, a second example of a head wearable binocular kaleidoscope, kaleidoscope 200, will now be described. Kaleidoscope 200 includes many similar or identical features to kaleidoscope 100. Thus, for the sake of brevity, each feature of kaleidoscope 200 will not be redundantly explained. Rather, key distinctions between kaleidoscope 200 and kaleidoscope 100 will be described in detail and the reader should reference the discussion above for features substantially similar between the two kaleidoscope.

As can be seen in FIG. 5A, kaleidoscope 200 includes a helmet shell 202. Arm 204 serves as a mount for the kaleidoscope members, and attaches to helmet shell 202 via pivot point 206. Pivot point 206 enables arm 204 to move between a storage position 210 and a use position 220. Helmet shell 202 is manufactured from any material now known or later developed suitable for providing a functional helmet, such as impact-resistant plastics like polycarbonate (known as Lexan®), or carbon-fiber composites. Helmet shell 202 may include internal structures appropriate to provide the protective functions of a helmet.

Pivot point 206 can be implemented using a screw, rivet, hinge, or any other mechanism that will allow arm 204 to rotate between storage position 210 and use position 220. Although not depicted in FIGS. 5A and 5B, arm 204 is preferably mounted using a plurality of pivot points 206, located on either side of helmet shell 202. However, pivot point 206 could potentially be implemented as a single hinge located above the brow line of helmet shell 202. In such an implementation, arm 204 would flip up from use position 220 into storage position 210, with the axes of the kaleidoscope members being oriented substantially parallel to the front surface of helmet shell 202.

Arm 204 acts in a similar function to mount 102, and includes similar features and construction.

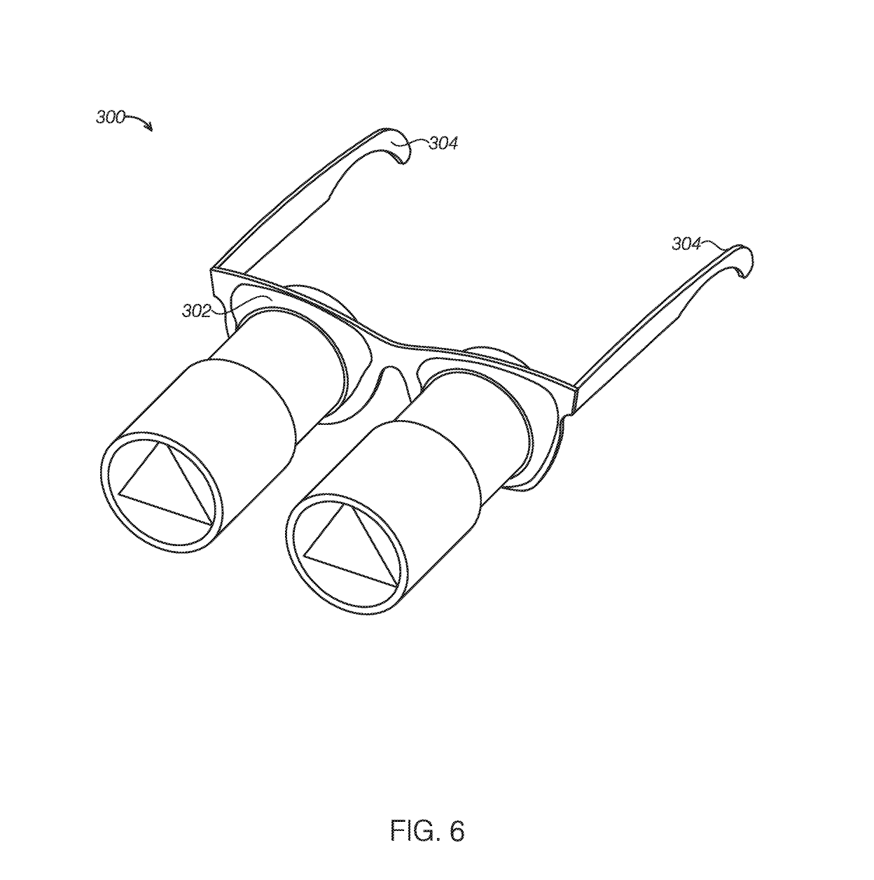

Turning attention to FIG. 6, a third example of a head wearable binocular kaleidoscope, kaleidoscope 300, will now be described. Kaleidoscope 300 includes many similar or identical features to kaleidoscope 100. Thus, for the sake of brevity, each feature of kaleidoscope 300 will not be redundantly explained. Rather, key distinctions between kaleidoscope 300 and kaleidoscope 100 will be described in detail and the reader should reference the discussion above for features substantially similar between the two kaleidoscope.

As can be seen in FIG. 6, kaleidoscope 300 includes a glasses frame 302 which serves as the mount tor the kaleidoscope members and associated components. Glasses frame 302 further includes ear pieces 304, which enable kaleidoscope 300 to be worn similar to a conventional pair of glasses. Glasses frame 302 serves the same functions as mount 102, and can be constructed from any suitable materials, such as plastic, wood, metal, composites, or any other similar material now known or later developed.

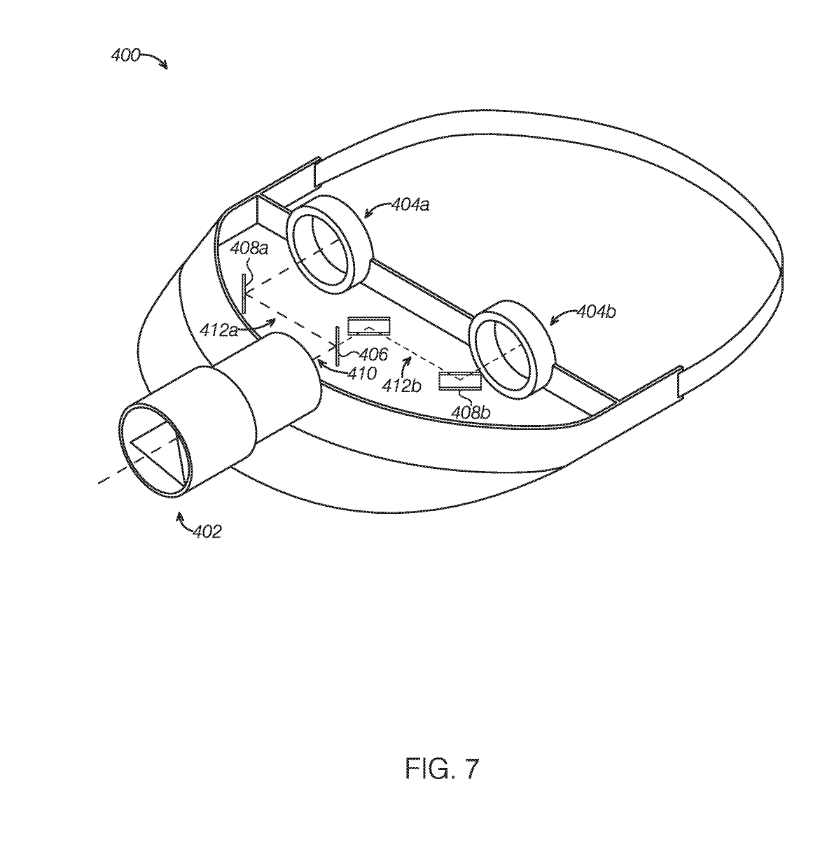

Turning attention to FIGS. 7, a second example of a head wearable binocular kaleidoscope, kaleidoscope 400, will now be described. Kaleidoscope 400 includes many similar or identical features to kaleidoscope 100. Thus, for the sake of brevity, each feature of kaleidoscope 400 will not be redundantly explained. Rather, key distinctions between kaleidoscope 400 and kaleidoscope 100 will be described in detail and the reader should reference the discussion above for features substantially similar between the two kaleidoscope.

In FIG. 7, kaleidoscope 400 is mounted on a visor mount similar to kaleidoscope 100. However, kaleidoscope 400 is equipped with only a single kaleidoscope member 402. Light passing through kaleidoscope member 402 is transmitted to left and right eyepieces 404a and 404b by an optical system that splits light 410 passing through kaleidoscope member 402 into two paths 412a and 412b. It will be appreciated by a person skilled in the relevant art that the optical system depicted in FIG. 7 will ordinarily be enclosed within the visor/mount body, and is depicted in a cutaway fashion only to show the internal components that comprise the optical system.

As FIG. 7 depicts, the optical system includes a splitting mirror assembly 406 which takes light 410 and diverts it into opposing paths 412a and 412b which are each roughly perpendicular to the travel path of light 410. Path 412a travels to reflector 408a, which diverts path 412a into the axis of eyepiece 404a, to be viewed by one of the user's eyes. Similarly, path 412b is diverted by reflector 408b into eyepiece 404b. In this way, the view illuminated by light traveling through single kaleidoscope member 402 is equally viewed by both the user's eyes. Mirror assembly 406 is depicted as a couplet of 45 degree mirrors. The portion of mirror assembly 406 proximate to kaleidoscope member 402 is preferably partially silvered so as to deflect only a portion of light 410 to path 412a, while the remainder is reflected to path 412b by the fully silvered portion of mirror assembly 406 that is proximate to the user. Reflectors 4048a and 408b are preferably fully silvered mirrors positioned at approximately 45 degree angles.

While the optical system described above is constructed using mirrors, a person skilled in the relevant art will understand that the optical system could be constructed using other optical mechanisms and techniques, such as a series of prisms. Furthermore, the elements of the optical system including mirror assembly 406 and reflectors 408a and 408b, while preferably manufactured from silvered glass, could be manufactured from any suitable optically transmissive or reflective material, such as glass, plastic, metal, or any other suitable material.

In keeping with the spirit of the disclosed invention, it will also be appreciated by a person skilled in the relevant art that various filters could be put in the paths of the optical system described above to achieve novel visual effects. Such filters could include color filters, diffusion filters, polarizing filters, gradient filters, neutral density filters, or any other device for modifying light passing through kaleidoscope member 402.

It will further be appreciated that other example kaleidoscope systems and features are contemplated. For example, the kaleidoscope systems can include a motor system tor automatically rotating the rotatable attachments. The motor system can be battery and/or solar powered. In the case of a solar powered motor system, a solar panel can be included on the visor portion of the head mount. In another example, the visor and the binocular kaleidoscope scaffold can be attached to the vertical curved wall via one or more hinges for moving the visor and binocular kaleidoscope scaffold between the raised and lowered positions.

The disclosure above encompasses multiple distinct inventions with independent utility. While each of these inventions has been disclosed in a particular form, the specific embodiments disclosed and illustrated above are not to be considered in a limiting sense as numerous variations are possible. The subject matter of the inventions includes all novel and non-obvious combinations and subcombinations of the various elements, features, functions and/or properties disclosed above and inherent to those skilled in the art pertaining to such inventions. Where the disclosure or subsequently filed claims recite “a” element, “a first” element, or any such equivalent term, the disclosure or claims should be understood to incorporate one or more such elements, neither requiring nor excluding two or more such elements.

Applicant(s) reserves the right to submit claims directed to combinations and subcombinations of the disclosed inventions that are believed to be novel and non-obvious. Inventions embodied in other combinations and subcombinations of features, functions, elements arid/or properties may be claimed through amendment of those claims or presentation of new claims in the present application or in a related application. Such amended or new claims, whether they are directed to the same invention or a different invention and whether they are different, broader, narrower or equal in scope to the original claims, are to be considered within the subject matter of the inventions described herein.

1. A head wearable kaleidoscope, comprising:
a plurality of kaleidoscope members; and
a mount that can be secured to a user's head,
wherein each of the plurality of kaleidoscope members are disposed within the mount so as to be positioned in front of one of the user's eyes.

2. The head wearable kaleidoscope of claim 1, wherein the mount comprises a visor.

3. The head wearable kaleidoscope of claim 2, wherein the visor further comprises an adjustable strap to retain the visor upon the user's head.

4. The head wearable kaleidoscope of claim 1, wherein the mount comprises a helmet.

5. The head wearable kaleidoscope of claim 4, wherein the mount further comprises:
a helmet shell; and
an arm attached to a pivot point, wherein
the plurality of kaleidoscope members are disposed upon the arm, and
the arm is configured to pivot upon the pivot point such that the plurality of kaleidoscope members can be positioned in a storage position opposite the helmet shell, above the user's eyes.

6. The head wearable kaleidoscope of claim 1, wherein the mount comprises a pair of glasses.

7. The head wearable kaleidoscope of claim 1, wherein each of the plurality of kaleidoscope members are configured to slide in the mount between a retracted position and a use position.

8. The head wearable kaleidoscope of claim 1, wherein each of the kaleidoscope members further comprises a teleidoscope.

9. The head wearable kaleidoscope of claim 1, wherein each of the kaleidoscope members further comprises:
a light inlet; and
a rotatable viewing object disposed upon the light inlet.

10. A head wearable kaleidoscope, comprising:
at least one kaleidoscope member;
a mount that can be secured to a user's head; and
an eyepiece for each of the user's eyes that transmits light passing through the at least one kaleidoscope member.

11. The head wearable kaleidoscope of claim 10, wherein the at least one kaleidoscope member comprises a single kaleidoscope member, and further comprising an optical system that conveys light transmitted through the one kaleidoscope member to each eyepiece.

12. The head wearable kaleidoscope of claim 11, wherein the optical system further comprises one or more mirrors.

13. The head wearable kaleidoscope of claim 11, wherein the optical system further comprises one or more prisms.

14. The head wearable kaleidoscope of claim 10, wherein the at least one kaleidoscope further comprises at least one teleidoscope.

15. The head wearable kaleidoscope of claim 10, wherein the at least one kaleidoscope member further comprises:
a light inlet; and
a rotatable viewing object disposed upon the light inlet.
